(19) United States
(12) Patent Application Publication
(10) Pub. No.: US 2020/0207113 A1
(43) Pub. Date: Jul. 2, 2020

(54) APPEARANCE ATTRIBUTES

(71) Applicant: Hewlett-Packard Development Company, L.P., Spring, TX (US)

(72) Inventors: Josep Maria Cuner Utges, Sant Cugat del Valles (ES); Leyre Hernandez Martinez, Sant Cugat del Valles (ES)

(21) Appl. No.: 16/631,292

(22) PCT Filed: Sep. 29, 2017
(86) PCT No.: PCT/US2017/054257

§ 371 Date: Jan. 15, 2020

(51) Int. Cl. B41J 2/21; B41J 2/045

(52) U.S. Cl. CPC B41J 2/2103; B41J 2/0458; B41J 2/04581; B41J 2/04536

(57) ABSTRACT

An example appearance calibration system includes a profile engine that identifies a printer setting corresponding to a non-color appearance attribute of an image source and a setting engine that sets a printer setting corresponding to the non-color appearance attribute. An example set of instructions may cause a processor resource to identify a setting corresponding to a printer component that affects an appearance attribute and provide layer appearance information representing a degree of the appearance attribute identified using a look-up table. An example method of appearance matching among a plurality of printers is described. In the example method, a plurality of appearance attributes controllable between a first printer and a second printer is identified, a degree of each attribute compatible with the first and second printer is determined, and instructions are prepared for the first and second printer using the degree of each attribute compatible with the first and second printer.

### BACKGROUND

Images are processed for use with computing machines, such as a print apparatus. A print apparatus, for example, may use control data based on processed image data to reproduce a physical representation of an image by operating a print fluid ejection system according to the control data. Image processing may include color calibration. An image may be processed in a print apparatus pipeline or processed offline on separate compute device, such as a print server.

### BRIEF DESCRIPTION OF THE DRAWINGS

FIGS. 1-5 are block diagrams depicting example appearance calibration systems.

FIG. 6 depicts an example environment in which various appearance calibration systems may be implemented.

FIG. 7 is a block diagram depicting an example appearance calibration system.

FIG. 8 depicts example components used to implement example appearance calibration systems.

FIGS. 9-15 are flow diagrams depicting example methods of appearance matching.

### DETAILED DESCRIPTION

In the following description and figures, some example implementations of print apparatus, appearance calibration systems, and/or methods of appearance matching are described. In examples described herein, a “print apparatus” may be a device to print content on a physical medium (e.g., paper, textiles, a layer of powder-based build material, etc.) with a print material (e.g., ink or toner). For example, the print apparatus may be a wide-format print apparatus that prints latex-based print fluid on a print medium, such as a print medium that is size A2 or larger. In some examples, the physical medium printed on may be a web roll or a pre-cut sheet. In the case of printing on a layer of powder-based build material, the print apparatus may utilize the deposition of print materials in a layer-wise additive manufacturing process. A print apparatus may utilize suitable print consumables, such as ink, toner, fluids or powders, or other raw materials for printing. In some examples, a print apparatus may be a three-dimensional (3D) print apparatus. An example of fluid print material is a water-based latex ink ejectable from a print head, such as a piezoelectric print head or a thermal inkjet print head. Other examples of print fluid may include dye-based color inks, pigment-based inks, solvents, gloss enhancers, fixer agents, and the like.

Certain examples described herein relate to color calibration of a print system. For example, color calibration may be used to adjust the color response of the print system to more accurately correspond to a desired color to be printed. Color calibration may be used to calibrate a color mapping process by which a first representation of a given color is mapped to a second representation of the same color. The concept of “color” can be represented in a large variety of ways, such as in relation to a power or intensity spectrum of electromagnetic radiation across a range of visible wavelengths or a color model is used to represent a color at a lower dimensionality. A “color” may be said to be a category that is used to denote similar visual perceptions where two colors are said to be similar if they produce a similar effect on a group of one or more people. These categories can then be modelled using a lower number of variables. In an example printing pipeline, individual inks may be calibrated separately so that printed colors are similar to or match desired colors.

Colors may be matched among print apparatus using colorimetric processes to assist uniformity of printed images from the devices. Color matching may provide a subset of appearance matching to print the output images into uniformity among print apparatus. Other appearance attributes may affect visual perception of an image and may or may not be affected by color. For example, an image may be rated with a degree of glossiness or grain where color may or may not be independent from such attributes. These non-color appearance attributes, if not matched, may result in outputs from different devices appearing differently even when the images are colorimetrically matched.

Various examples described below relate to appearance calibration of non-color appearance attributes. The appearance calibration may involve providing levels of non-color appearance attributes to a printer and/or adjusting printer settings according to data representing non-color appearance attributes. By defining a framework to coordinate appearance attributes, appearance calibration may occur by using printer characteristic information transferred to a print apparatus in terms of appearance attributes that are controllable by the print apparatus, for example, using a look-up table (LUT) with entries corresponding to appearance settings specific to a particular print apparatus. In this manner, non-color appearance attributes are calibrated so that images printed by different print apparatus are similar to or match desired appearance characteristics.

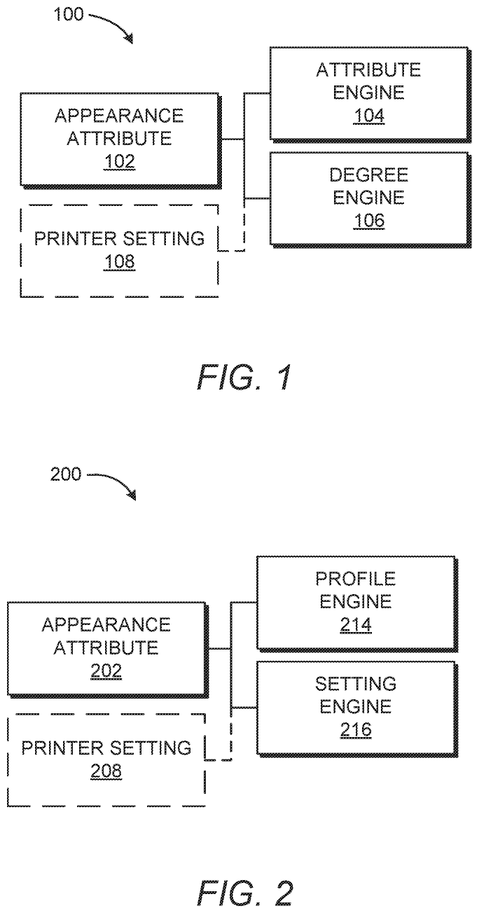

FIGS. 1-5 are block diagrams depicting example appearance calibration systems 100, 200, 300, 400, and 500. Referring to FIG. 1, the example appearance calibration system 100 of FIG. 1 generally includes an attribute engine 104 and a degree engine 106. In general, the attribute engine 104 may identify a printer setting 108 that affects an appearance attribute 102 and the degree engine 106 may identify a degree of the appearance attribute 102 corresponding to the printer setting 108. As used herein, a printer setting is a characteristic of a print apparatus that corresponds to an operational parameter for performing a print process. As used herein, an appearance attribute is a characteristic of an image to be printed regarding the visibility of printed image (e.g., how the image looks).

The attribute engine 104 represents any circuitry or combination of circuitry and executable instructions to identify an appearance attribute 102 corresponding to a printer setting 108. For example, the printer setting 108 may correspond to an orientation or speed of a printer component, such as orientation of a scan axis of a print carriage, and the attribute engine 104 may be a combination of circuitry and executable instructions that, when executed, identify that grain is an appearance attribute 102 that is affected by the orientation of the scan axis of the print carriage. A non-color appearance attribute is an appearance attribute that is not colormetric (e.g., is not a color, a tone, a hue, contrast, brightness, or other value used in a color model to define a color within a color space). A non-color appearance attribute may be color independent (i.e., the attribute can change without affecting the perceived color beyond a visible threshold to the human eye) or color dependent (i.e., the perceived color may change beyond the visible threshold of the human eye when the attribute changes.) Example color independent appearance attributes may include gloss, grain, sharpness, macro uniformity, micro uniformity, text quality, line quality, and line roughness. Example color dependent appearance attributes may include coalescence, mottle, haze, and bronzing (i.e., an affect of a change of the ink over time, such as in an aged treatment fluid). Some non-color attributes may or may not be affected by color or may or may not make an effect on color depending on operational conditions. For example, grain adjustments on cyan area, magenta, or yellow fill area may change LAB definition based on the grain changes, where grain adjustments of a black fill area may not change LAB definitions. In an example where the appearance attribute is color dependent, the printer setting may be adjusted differently based on the output color in order to generate a uniformity in the appearance attribute to be matched. In that example, the image source may be embedded with an additional plane of pixel color dependent change of the appearance attribute and/or an LUT to be used for matching may include additional entries according to the color dependency, as discussed with regards to example further herein.

The degree engine 106 represents any circuitry or combination of circuitry and executable instructions to identify a degree of the appearance attribute corresponding to the printer setting. For example, the degree engine 106 may be a combination of circuitry and executable instructions that correlate the angle of the scan axis of the print carriage with respect to the platen to a level of graininess, such as by performing a prediction calculation or looking up the value in a table of setting entries.

Referring to FIG. 2, the example appearance calibration system 200 of FIG. 2 generally includes a profile engine 214 and a setting engine 216. In general, the profile engine 214 may identify a printer setting 208 corresponding to an appearance attribute 202 and the setting engine 216 may set the printer setting 208 to coordinate with the degree of the appearance attribute 202.

The profile engine 214 represents any circuitry or combination of circuitry and executable instructions to identify a printer setting 208 corresponding to a non-color appearance attribute of an image source. For example, the profile engine 214 may be a combination of circuitry and executable instructions to identify a printer component and a printer setting 208 corresponding to a color-independent appearance attribute of an image source.

The setting engine 216 represents any circuitry or combination of circuitry and executable instructions to set the printer setting according to the non-color appearance attribute of the image source. For example, the setting engine 216 may be a combination of circuitry and executable instructions that, when executed, identify a degree of a color independent appearance attribute, identify a degree of a printer setting corresponding to the color independent appearance attribute, and set a printer component to a configuration (e.g., position, orientation, speed, etc.) corresponding to the printer setting at the identified degree.

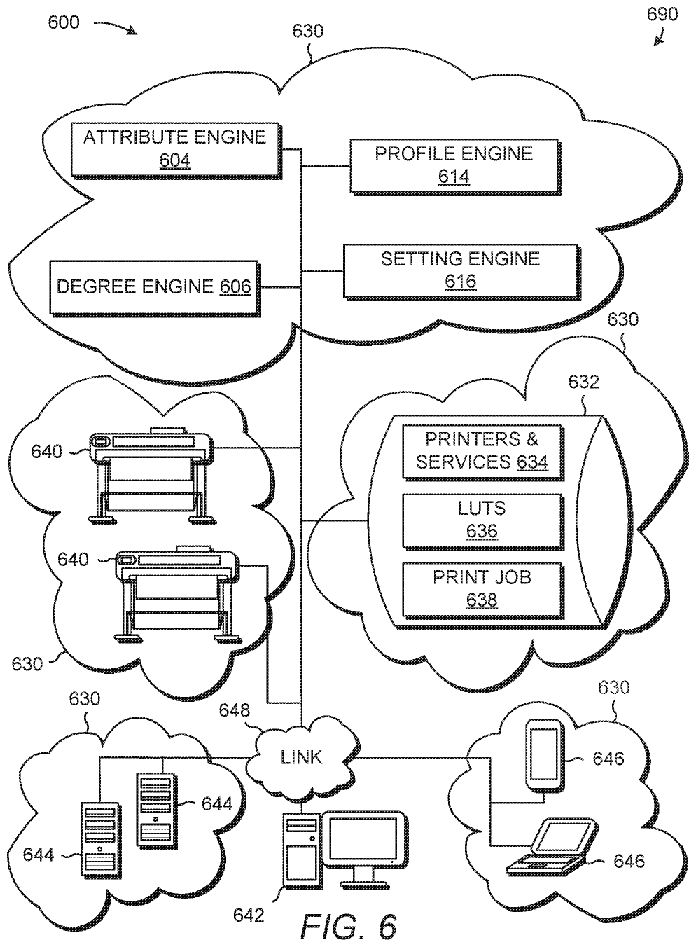

In some examples, functionalities described herein in relation to any of FIGS. 1-5 may be provided in combination with functionalities described herein in relation to any of FIGS. 6-15.

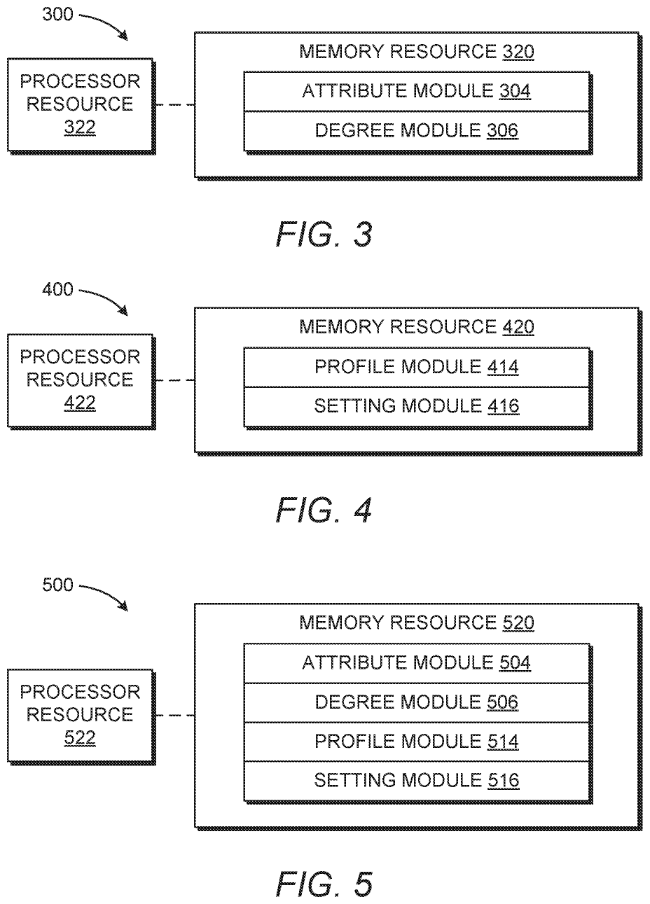

FIGS. 3-5 depict the example systems 300, 400, and 500 may comprise a memory resource (e.g., a memory resource 320, 420, and 520, respectively) operatively coupled to a processor resource (e.g., processor resource 322, 422, and 522, respectively).

Referring to FIG. 3, the memory resource 320 may contain a set of instructions that are executable by the processor resource 322. The set of instructions are operable to cause the processor resource 322 to perform operations of the system 300 when the set of instructions are executed by the processor resource 322. The set of instructions stored on the memory resource 320 may be represented as an attribute module and a degree module 306. Referring to FIG. 4, the set of instructions (represented as a profile module 414 and a setting module 416) stored on memory resource 420 are operable to cause the processor resource 422 to perform operations of the system 400 when the set of instructions are executed by the processor 422. Referring to FIG. 5, the set of instructions (represented as an attribute module 504, a degree module 506, a profile module 514, and a setting module 516) stored on memory resource 520 are operable to cause the processor resource 522 to perform operations of the system 500 when the set of instructions are executed by the processor 522. In general, the system 300 represents a system that is able to identify a degree of an appearance attribute to match, the system 400 represents a system that is able to set a printer setting (e.g., set a printer component) to match a degree of an appearance attribute, and the system 500 represents the functionalities of both the systems 300 and 400 integrated into single system, such as a web server that performs an appearance matching service external to the network of printers to be matched and provides instructions to the network of printers based on the appearance matching calibration operations.

The attribute modules, the degree modules, the profile modules, and the setting modules represent program instructions that when executed function as the attribute engine 104 of FIG. 1, the degree engine 106 of FIG. 1, the profile engine 214 of FIG. 2, and the setting engine 216 of FIG. 2, respectively. The processor resource (e.g., 322, 422, and 522) may carry out a set of instructions to execute the modules 304, 306, 414, 416, 504, 506, 514, 516, and/or any other appropriate operations among and/or associated with the modules of the system. For example, the processor resource 322 may carry out a set of instructions to identify a setting corresponding to a printer component that affects an appearance attribute, identify a degree of the appearance attribute using a look-up table entry corresponding to the setting, and provide a layer of appearance information corresponding to an image source representing the degree of the appearance attribute. For another example, the processor resource 422 may carry out a set of instructions to identify a printer setting of a printer component corresponding to a non-color appearance attribute of an image source and set the printer component according to a degree of the non-color appearance attribute of the image source. For yet another example, the processor resource 522 may carry out a set of instructions to identify a list of appearance attributes controllable among a plurality of printers using printer profiles, determine a degree of each attribute of the list that is compatible among the printer pool based on the printer profiles, and prepare instructions for the plurality of printers to print a job using the degree of each attribute that is compatible among the plurality of printers.

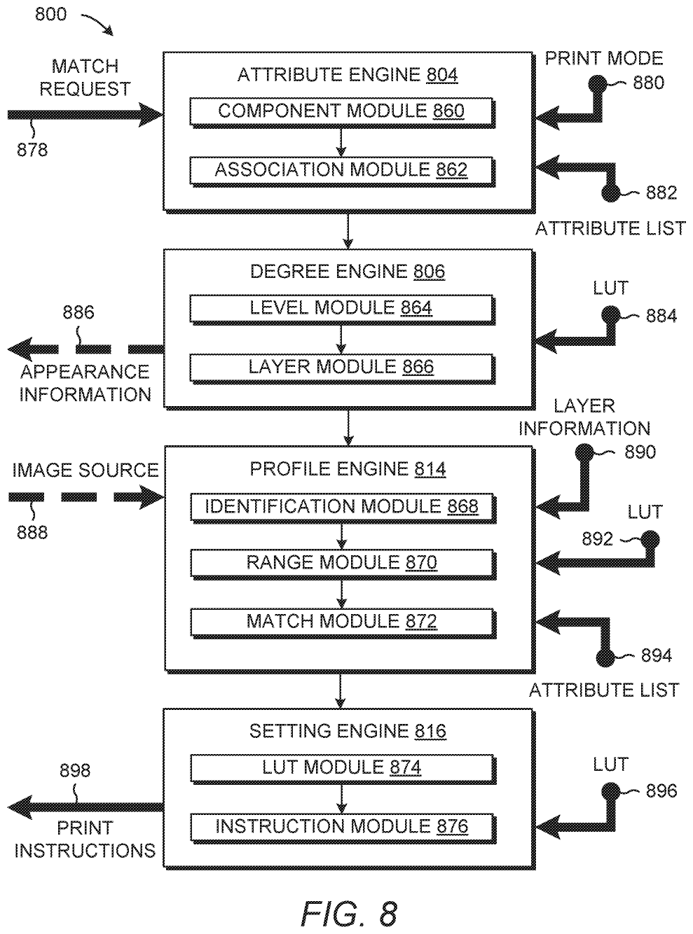

Although these particular modules and various other modules are illustrated and discussed in relation to FIGS. 3-5 and other example implementations, other combinations or sub-combinations of modules may be included within other implementations. Said differently, although the modules illustrated in FIG. 3-5 and discussed in other example implementations perform specific functionalities in the examples discussed herein, these and other functionalities may be accomplished, implemented, or realized at different modules or at combinations of modules. For example, two or more modules illustrated and/or discussed as separate may be combined into a module that performs the functionalities discussed in relation to the two modules. As another example, functionalities performed at one module as discussed in relation to these examples may be performed at a different module or different modules. FIG. 8 depicts yet another example of how functionality may be organized into modules.

A processor resource is any appropriate circuitry capable of processing (e.g., computing) instructions, such as one or multiple processing elements capable of retrieving instructions from a memory resource and executing those instructions. For example, the processor resource 522 may be a central processing unit (CPU) that enables appearance calibration by fetching, decoding, and executing modules 504, 506, 514, and 516. Example processor resources include at least one CPU, a semiconductor-based microprocessor, a programmable logic device (PLD), and the like. Example PLDs include an application specific integrated circuit (ASIC), a field-programmable gate array (FPGA), a programmable array logic (PAL), a complex programmable logic device (CPLD), and an erasable programmable logic device (EPLD). A processor resource may include multiple processing elements that are integrated in a single device or distributed across devices. A processor resource may process the instructions serially, concurrently, or in partial concurrence.

A memory resource represents a medium to store data utilized and/or produced by the system 300, 400, and 500. The medium is any non-transitory medium or combination of non-transitory media able to electronically store data, such as modules of the system and/or data used by the system. For example, the medium may be a storage medium, which is distinct from a transitory transmission medium, such as a signal. The medium may be machine-readable, such as computer-readable. The medium may be an electronic, magnetic, optical, or other physical storage device that is capable of containing (i.e., storing) executable instructions. A memory resource may be said to store program instructions that when executed by a processor resource cause the processor resource to implement functionality of the system. A memory resource may be integrated in the same device as a processor resource or it may be separate but accessible to that device and the processor resource. A memory resource may be distributed across devices.

In the discussion herein, the engines 102, 104, 214, and 216 of FIGS. 1-2 and the modules 304, 306, 414, 416, 504, 506, 514, and 516 of FIGS. 3-5 have been described as circuitry or a combination of circuitry and executable instructions. Such components may be implemented in a number of fashions. Looking at FIG. 5, the executable instructions may be processor-executable instructions, such as program instructions, stored on the memory resource 520, which is a tangible, non-transitory computer-readable storage medium, and the circuitry may be electronic circuitry, such as processor resource 522, for executing those instructions. The instructions residing on a memory resource may comprise any set of instructions to be executed directly (such as machine code) or indirectly (such as a script) by a processor resource.

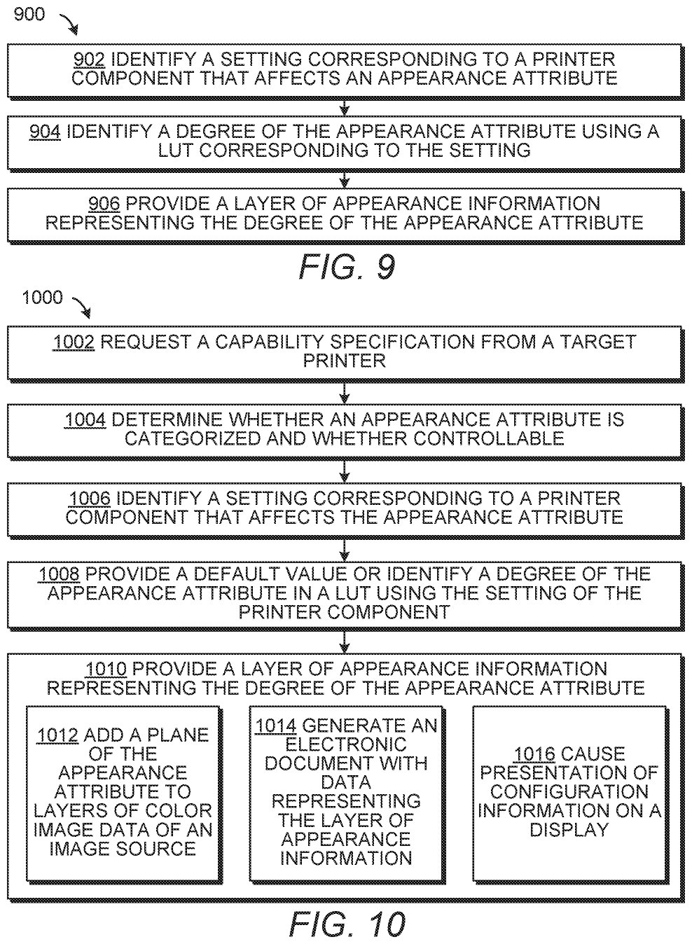

In some examples, the systems 300, 400, and 500 may include the executable instructions may be part of an installation package that when installed may be executed by a processor resource to perform operations of the systems 300, 400, and 500, such as methods described with regards to FIGS. 9-15. In that example, a memory resource may be a portable medium such as a compact disc, a digital video disc, a flash drive, or memory maintained by a computer device, such as a service device 644 of FIG. 6, from which the installation package may be downloaded and installed. In another example, the executable instructions may be part of an application or applications already installed. A memory resource may be a non-volatile memory resource such as read only memory (ROM), a volatile memory resource such as random access memory (RAM), a storage device, or a combination thereof. Example forms of a memory resource include static RAM (SRAM), dynamic RAM (DRAM), electrically erasable programmable ROM (EEPROM), flash memory, or the like. A memory resource may include integrated memory such as a hard drive (HD), a solid state drive (SSD), or an optical drive.

FIG. 6 depicts example environments in which various example appearance calibration systems may be implemented. The example environment 690 is shown to include an example system 600 for appearance calibration. The system 600 (described herein with respect to FIGS. 1-5) may represent generally any circuitry or combination of circuitry and executable instructions to appearance calibration. The system 600 may include an attribute engine 604, a degree engine 606, a profile engine 614, and a setting engine 616 that are the same as the attribute engine 104 of FIG. 1, the degree engine 106 of FIG. 1, the profile engine 214 of FIG. 2, and the setting engine 216 of FIG. 2, respectively, and the associated descriptions are not repeated for brevity. As shown in FIG. 6, the engines 604, 606, 614, and 616 may be integrated into a compute device, such as a print apparatus 640 or a print server 644. The engines 604, 606, 614, and 616 may be integrated via circuitry or as installed instructions into a memory resource of the compute device.

The example environment 690 may include compute devices, such as print apparatus 640, developer devices 642, service devices 644, and user devices 646. A print apparatus 640 may be devices identified for output of a print job. An image source may be developed and/or modified on a developer device 642. For example, a graphic may be developed and modified on a developer device 642 and stored onto a web server, such as a service device 644. The service devices 644 represent generally any compute devices to respond to a network request received from a user device 646, whether virtual or real. For example, the service device 644 may operate a combination of circuitry and executable instructions to provide a network packet in response to a request for a page or functionality of an application. The user devices 646 represent generally any compute devices to communicate a network request and receive and/or process the corresponding responses. For example, a browser application may be installed on the user device 646 to receive the network packet from the service device 644 and utilize the payload of the packet to display an element of a page via the browser application.

The compute devices may be located on separate networks 630 or part of the same network 630. The example environment 690 may include any appropriate number of networks 630 and any number of the networks 630 may include a cloud compute environment. A cloud compute environment may include a virtual shared pool of compute resources. For example, networks 630 may be distributed networks comprising virtual computing resources. Any appropriate combination of the system 600 and compute devices may be a virtual instance of a resource of a virtual shared pool of resources. The engines and/or modules of the system 600 herein may reside and/or execute “on the cloud” (e.g., reside and/or execute on a virtual shared pool of resources).

A link 648 generally represents one or a combination of a cable, wireless connection, fiber optic connection, or remote connections via a telecommunications link, an infrared link, a radio frequency link, or any other connectors of systems that provide electronic communication. The link 648 may include, at least in part, intranet, the Internet, or a combination of both. The link 648 may also include intermediate proxies, routers, switches, load balancers, and the like.

The data store 632 is accessible engines of the appearance calibration system 600 and may contain information utilized by the engines 604, 606, 614, and 616. For example, the data store 632 may store a list 634 of printers and services on the network, LUTs 636 used by the appearance calibration system 600, and the information 638 of the print job, such as the image source file.

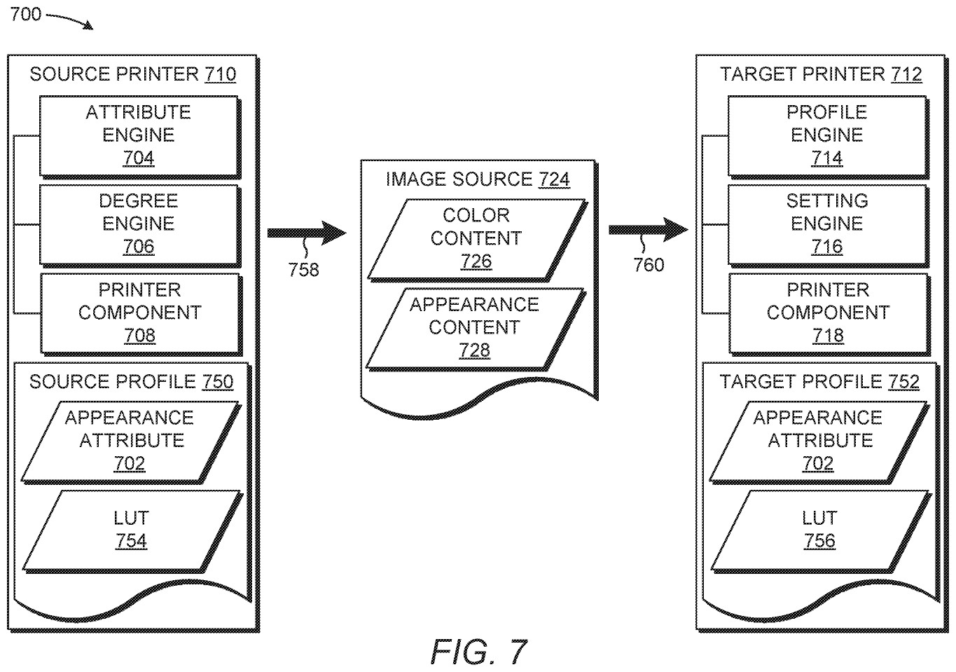

Referring to FIGS. 1-6, the engines 104, 106, 214, and 216 of FIGS. 1 and 2 and/or the modules 304, 306, 414, 416, 504, 506, 514, and 516 of FIGS. 3-5 may be distributed across devices 640, 642, 644, 646, or a combination thereof. The engine and/or modules may complete or assist completion of operations performed in describing another engine and/or module. For example, the profile engine 614 of FIG. 6 may request, complete, or perform the methods or operations described with the profile engine 214 of FIG. 2 as well as the attribute engine 104 of FIG. 1, the degree engine 106 of FIG. 1, and the setting engine 216 of FIG. 2. Thus, although the various engines and modules are shown as separate engines in FIGS. 1-6, in other implementations, the functionality of multiple engines and/or modules may be implemented as a single engine and/or module or divided in a variety of engines and/or modules. In some example, the engines of the system 600 may perform example methods described in connection with FIGS. 7-15.

FIG. 7 is a block diagram depicting an example appearance calibration system 700 where the appearance calibration system 700 includes components distributed among devices 710 and 712. The example appearance calibration system 700 of FIG. 7 functions to match a setting of a printer component 718 of a target printer 712 with a setting of a printer component 708 of a source printer 710. The source printer 710 includes an attribute engine 704 and a degree engine 706 that are the same as the attribute engine 104 and the degree engine 106 of FIG. 1. The target printer 712 includes a profile engine 714 and a setting engine 716 that are the same as the profile engine 214 and the setting engine 216 of FIG. 2.

In the example of FIG. 7, an appearance attribute 702 and a degree associated with the appearance attribute 702 is identified based on a setting of the printer component 708 and a LUT 754. In the example of FIG. 7, the appearance calibration information is placed into an image source 724 as depicted by arrow 758. The image source 724 may include a plurality of layers corresponding to a plurality of appearance attributes where at least one of the appearance attribute of the plurality of appearance attributes is a non-color appearance attribute. For example, a plane of appearance attribute information may be added to the layers of color image data of the image source 724, such that the image source 724 of FIG. 7 contains color content information 726 as well as appearance content information 728, including information corresponding the appearance attribute 702, such as the degree of the appearance attribute 702. In an example, an image source may be in a standard Red Green Blue (sRGB) format containing a number of color layers including a red plane, green plane, and a blue plane, and a number of appearance layers including a gloss plane and a grain plane. The appearance calibration system 700 may embed the appearance content in the image source, for example, by editing the header file to include additional layer profiles and appending the additional appearance layer information to the RGB plane profiles. The attribute information may be encoded in an independent space (i.e., measured in a standard way under particular conditions). An independent space may allow for the attribute information to be able to exchange attribute magnitude information across various platforms and technologies that may differ on how attributes are adjusted. An international standard organization (ISO) framework may be used such as the international color consortium (ICC) framework, which may be compatible with various print apparatus. For example, a gloss attribute may be defined as ISO 2813 regarding paints and varnishes where the determination of specular gloss of non-metallic paints and films are made at specific angles of reflection, such as 20 degrees, 50 degrees, and 85 degrees. In this manner, a print apparatus may be compatible with any number of non-color appearance attributes and may not be restricted to a particular type or number of appearance attributes to perform an appropriate calibration. For example, the profile engine may determine a subset of the plurality of appearance attributes that are compatible with the print apparatus corresponding to the printer setting of the appropriate print component. For example where an image source includes grain and sharpness appearance information, and the grain is not controllable on a print apparatus, the sharpness layer of the image source is used to perform appearance calibration on the print apparatus while the grain layer is disregarded for appearance calibration purposes.

The image source 724 is provided to the target printer 712 as depicted by arrow 760. In other examples, the appearance information may be transferred in a separate electronic document and/or via a communication protocol useable between the devices 710 and 712. The target printer 712 uses the color content information 726 and the appearance content information 728 to replicate the image source 724 as would be printed on the source printer 710 by identifying a setting for the printer component 718 that corresponds to the appearance attribute 702 as defined by the appearance content information 728. The profile engine 714 may identify a LUT 756 corresponding to the non-color appearance attribute of the image source and identify a setting level to apply to the printer component 718 via an entry in the LUT 756 corresponding to the degree of the non-color appearance attribute of the image source. For example, an LUT 756 may be used to identify a degree of the setting for the printer component that corresponds to the appearance attribute 702 and the degree of the appearance attribute corresponding to the printer component 708 of the source printer 710. In this manner, the LUTs usable by each print apparatus may be different, yet compatible as long as at least one appearance attribute is available among the LUTs.

In some examples, the printer components 708 and 718 may be different types of printer components, such as changing a scan axis in a target printer 712 may be adjustable to substantially match the paper axis setting of the source printer 710. For example, the type of the printer component 708 of the source printer 710 may not be the same as the type of the printer component 718 of the target printer 712 (though both print components may effectively adjust the appearance attribute 702). For another example, a profile engine 714 may determine that the setting level corresponding to the degree of the non-color appearance attribute 702 of the image source 724 is beyond a configuration range of a first printer component corresponding to the non-color appearance attribute of the image source, identify that the setting level corresponding to the degree of the non-color appearance attribute of the image source is within a tolerance threshold of a second printer component, and select the second printer component and corresponding setting level as an alternative to the first printer component.

An example data structure including a look-up table may include information corresponding to classifications of the appearance attribute and/or print apparatus configurations. For example, the data structure may include a look-up table and appearance space information, a description (such as a print mode), color-dependency information, a list of printer settings and/or printer components that affect the appearance attribute, and a table of setting levels corresponding to each of the printer settings and/or printer components to replicate the appearance attribute at a particular number of degrees available for adjustment at the print apparatus. A LUT data structure may include a number of LUTs. For example, an LUT may include an operable characterization table and a default characterization table. In another example, the LUT data structure may include a table for each print mode offered by a print apparatus. In yet another example, LUTs for each controllable attribute may be stored in the same data structure or stored in multiple separate data structures. The LUT entries may include specific values or ranges corresponding to a degree of an appearance attribute capable by adjust the printer settings/printer components accordingly.

Some physical components directly affect appearance attributes and some indirectly affect appearance attributes. For example, paper advance accuracy and carriage advance may affect grain or dot placement/error generally. Example printer component settings that may be adjustable to affect non-color appearance attributes include physical component positioning (such as scan axis, a paper axis, media-to-printhead spacing), fluid ejection settings (including drop volume as affected by voltage and/or energy levels and treatment fluid amount, such as an amount of varnish, overcoat, optimizer, binder, and the like), and pipeline settings (such as drop layering order and masking).

FIG. 8 depicts example components used to implement example appearance calibration systems 800. Referring to FIG. 8, the example components of FIG. 8 generally include an attribute engine 804, a degree engine 806, a profile engine 814, and a setting engine 816. The example components of FIG. 8 may be implemented on a compute device, such as a print server.

A match request 878 is received by the attribute engine 804. The attribute engine 804 includes program instructions, such as a component module 860 and an association module 862, to assist identification of a printer component setting to replicate. The component module 860 represents program instructions that when executed cause a processor resource to identify a printer component. For example, a list 882 of controllable components may be used by the attribute engine to identify the components that are adjustable and may affect an appearance attribute. The association module 862 represents program instructions that when executed cause a processor resource to identify the appearance attributes the corresponds to the identified component. For example, a list 882 of controllable components may be used to identify which attributes are adjustable on a print apparatus based on the controllability of the printer components. For another example, the components/settings and the degrees of settings may be identified based on the print modes 880 available to a printer. For example, a print mode 880 may be selected and, by executing the attribute engine 604, a set of LUTs 884 may be identified that retrieve appearance attribute information corresponding to the print mode 880.

The degree engine 806 includes program instructions, such as a level module 864 and a layer module 866, to assist providing a degree of the appearance attribute to match. The level module 864 represents program instructions that when executed cause a processor resource to identify the setting level corresponding to the condition of the printer component (e.g., in the appropriate print mode). For example, the level module 864, when executed, may cause a processor resource to retrieve LUT 884 to identify a degree of the print setting corresponding to a print mode and desired output. The layer module 866 represents program instructions that when executed cause a processor resource to generate layer information corresponding to the degree of the appearance attribute with regards to the image source, such as the whole image source or a portion of the image source.

The match request 878 may include an operation to request a capability specification from a target printer. As used herein, a capability specification may be a data structure defining a profile of characteristics of a print apparatus. With respect to match request 878, the capability specification includes a range of an appearance attribute available on the target printer. For example, the source printer may only provide an appearance attribute within the range of a destination printer. In other examples, a measurement device may be used to measure the range of the appearance attribute available on the target printer using a calibration technique, such as to discover a default appearance attribute of a print apparatus. The degree engine 814 may determine the degree of the appearance attribute that is within the range of the appearance attribute available on the target printer using an appearance mapping technique. In this manner, the degree of the non-color appearance attribute of the image source is based on a target setting of a target printer component of a target print apparatus.

The degree engine 806 may provide appearance information 886 to another device to complete the matching (e.g., via providing a modified image source 888 with appearance information to a print apparatus with a profile engine and setting engine) or may continue onto further appearance calibration operations (e.g., perform the calibration operations as a web service and provide the printer-specific instructions to a target printer from the web server).

In either manner, a profile engine 814 receives the appearance information 886 to calibrate a settings match with a print apparatus using the setting engine 816. The profile engine 814 includes program instructions, such as an identification module 868, a range module 870, and a match module 872, to assist identification of a printer setting adjustable to replicate an appearance attribute. The identification module 868 represents program instructions that when executed cause a processor resource to identify appearance attribute information 886 corresponding to a print setting of a print apparatus. For example, layer information 890 may be parsed for compatible appearance attributes by a processor resource from the image source 888 by executing the identification module 866. The range module 870 represents program instructions that when executed cause a processor resource to identify a plurality of settings corresponding to an appearance attribute. For example, execution of the range module may produce an attribute list 894 including various components and/or settings may be alterable to modify an appearance attribute and each may have a varying degree of effect on the appearance attribute, where the match module 872 may be executed to retrieve the best settings match for replicating the appearance attribute. The match module 872 represent program instructions that when executed cause a processor resource to retrieve an entry in an LUT 892 corresponding to the printer setting and/or print component to be adjusted to achieve the appearance attribute level of the layer information 890. The entry may be retrieved based on a best match policy or other match policy.

The setting engine 816 includes program instructions, such as a LUT module 874 and an instruction module 876, to assist preparing instructions for a print apparatus to set a printer setting and/or printer component to produce an appearance attribute at the degree in accordance with the layer information 890. The LUT module 874 represents program instructions that when executed cause a processor resource to retrieve a setting level corresponding to a degree of the appearance attribute of the layer information 890 using a LUT 896. For example, a graininess level retrieved from the layer information 890 may correspond to a draft print mode setting level of a scan axis alignment according to the LUT 896. The LUT 896 may be the same as the LUT 892 or may be a different LUT. The instruction module 876 represents program instructions that when executed cause a processor resource to generate print instructions 898 to control a print apparatus to set a printer setting and/or printer component to a condition to produce the appearance attribute at the degree of the layer information 890, which in the example of FIG. 8, should be substantially close or match the appearance attribute degree identified by the degree engine 806.

FIGS. 9-15 are flow diagrams depicting example methods of appearance calibration. Methods 900, 1000, 1100, 1200, 1300, 1400, and 1500 are performable by a combination of the engines described herein. Referring to FIG. 9, a method 900 of appearance calibration generally includes identifying a setting and a degree of the appearance attribute and providing the degree of the appearance attribute as a layer of appearance information.

At block 902, a setting corresponding to a printer component that affects an appearance attribute is identified. At block 904, a degree of the appearance attribute is identified using a look-up table entry corresponding to the setting identified at block 902. At block 906, a layer of appearance information representing the degree of the appearance attribute is provided, such as to print apparatus.

FIG. 10 includes blocks similar to the blocks of FIG. 9 and provides additional blocks and details. In particular, method 1000 of FIG. 10 depicts additional blocks and details generally regarding determining controllability of appearance attributes, providing default values, and particular avenues to provide the appearance information. Blocks 1006 is the same as blocks 902 and, for brevity, the respective description is not repeated.

At block 1002, a capability specification is requested from a target printer. The capability specification may include a plurality of the appearance attributes available on the target printer. In other examples, the capabilities of a printer may be measured by a measuring device. By retrieving information about a target printer (and/or a source printer) the degree of the appearance attribute may be limited to be within the capabilities of the printers being matched.

At block 1004, a processor resource determines whether an appearance attribute is categorized and whether the appearance attribute is controllable. At block 1008, a default value is provided when the appearance attribute is determined to be categorized and uncontrollable or the degree of the appearance attribute is identified in a look-up table using the setting of the printer component when the appearance attribute is determined to be categorized and controllable.

At block 1010, the appearance information may be provided in a number of ways. Examples are depicted by blocks 1012, 1014, and 1016. At block 1012, a plane of the appearance attribute is added to layers of color image data of an image source. At block 1014, an electronic document with data representing the layer of appearance information is generated in a format compatible with a target printer and then provided to the target printer by a compatible communications protocol. At block 1016, configuration information is caused to be presented on a display. The configuration information may correspond to adjustments to be made on the target printer to replicate the degree of the appearance attribute, which may be provided as textual instructions, audio instructions, animations, and/or an instructional video as examples. Example displays include a touchscreen control panel on a print apparatus, a mobile device such as telephone or tablet, and a computer monitor coupled to a desktop computer or a point of sale device.

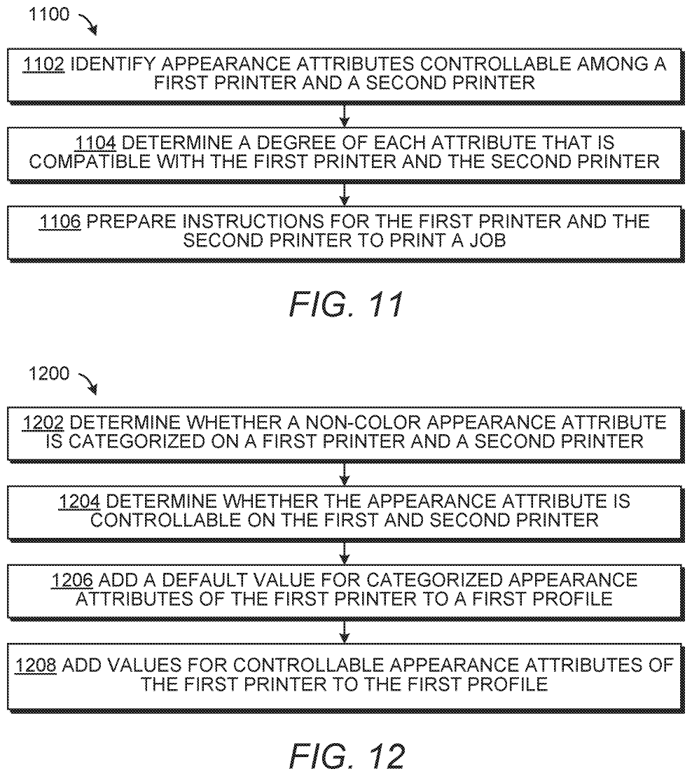

Referring to FIG. 11, an example method 1100 for appearance matching may generally comprise identifying a plurality of appearance attributes among a plurality of print apparatus, determining a degree of each attribute compatible with the plurality of print apparatus, and preparing instructions for the plurality of printers to print a job in a manner substantially matching among the plurality of devices.

At block 1102, a number of appearance attributes are identified that are controllable between a first profile corresponding to a first printer of the plurality of printers and a second profile corresponding to a second printer of the plurality of printers. For example, a list of appearance attributes may be generated and/or retrieved by a profile engine, such as profile engine 214, where the list includes a non-color appearance attribute.

At block 1104, a degree of each attribute of the plurality of appearance attributes that is compatible with the first printer and the second printer is determined based on the first profile and the second profile. For example, a first printer profile may include gloss and grain between as a controllable appearance attribute and a second printer profile may include gloss as a controllable appearance attribute. In that example, gloss may be identified as a controllable appearance attribute among the profiles. Further, if a range of gloss for the first profile is 50 to 80 units (e.g., gloss units) and a range of gloss for a second profile is 60 to 100 units, then a degree determined to be compatible among the printers may be a range of 60 to 80 units. A unit of appearance attribute with respect to each printer profile may be standardized or otherwise uniform measurement across profiles for accurate translation using an appearance calibration system (e.g., a unit of measurement may be related to an ISO of measurement for a particular appearance attribute).

At block 1106, instructions are prepared for the first printer and the second printer to print a job using the degree of each attribute that is compatible with the first printer and the second printer. Instructions may be general print instructions according to a compatible printer description language (PDL) or may be printer-specific instructions.

FIGS. 12-15 describe methods of appearance matching that may be in addition to a method 1100 of appearance matching of FIG. 11. Referring to FIG. 12, a method 1200 of appearance matching may include identification of an appearance attribute as categorized and controllable. At block 1202, a processor resource determines whether the non-color appearance attribute is categorized on the first printer and on the second printer. At block 1204, a processor resource determines whether the non-color appearance attribute is controllable on the first printer and the second printer. At block 1206, a default value is added for each of the categorized appearance attributes of the first printer to the first profile. At block 1208, a number of values (e.g., a discrete plurality of values and/or a range of values) are added for each of the controllable appearance attributes of the first printer to the first profile. Blocks 1202-1208 may be repeated for a number of printers and/or appearance attributes to be matched.

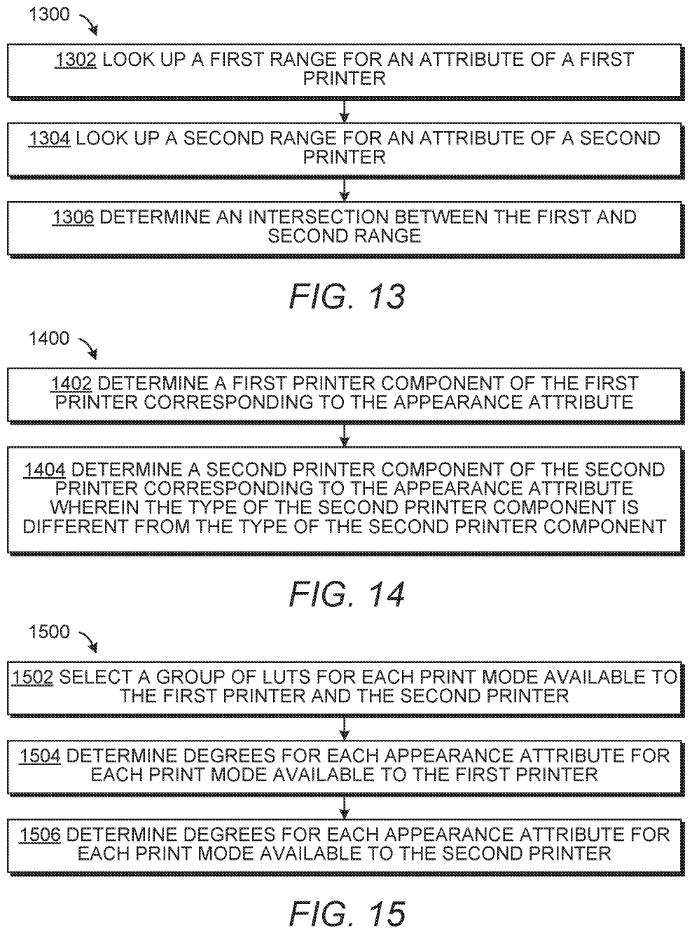

Referring to FIG. 13, a method 1300 of appearance matching may include using a look-up table to identify appropriate ranges among printers. At block 1302, a first range for each attribute of the plurality of appearance attributes for the first printer is looked up in an appearance attribute table. At block 1304, a second range for each attribute of the plurality of appearance attributes for the second printer is looked up in an appearance attribute table (which may be the same table as used with block 1302 or a different table). At block 1306, an intersection between the first range and the second range is determined. The intersection may be a specific value or a range of values to be used as the degree of the appearance attribute to be instructed to each of the plurality of print apparatus.

Referring to FIG. 14, a method 1400 of appearance matching may include determining particular components of each print apparatus to adjust or set in a condition to produce the degree of appearance attribute. At block 1402, a first printer component of the first printer is determined to correspond to the non-color appearance attribute. At block 1404, a second printer component of the second printer is determined to correspond to the non-color appearance attribute. There may be multiple ways to reproduce the non-color appearance attribute so each printer may have a different type of component, or maybe a component doesn't have sufficient range to reproduce the non-color appearance attribute to the desired degree, so a processor resource may select a type of the first printer component that is different from a type of the second printer component.

Referring to FIG. 15, a method 1500 of appearance matching may include selecting a group of look-up tables appropriate for print conditions among the plurality of printers. At block 1502, a group of look-up tables is selected for each print mode available to the first printer and the second printer. In this manner, degrees of an appearance attribute may vary based on print modes usable across devices, whether compatible or not on each device. At block 1504, degrees for each appearance attribute of the plurality of appearance attributes are determined for each print mode available to the first printer. At block 1506, degrees for each appearance attribute of the plurality of appearance attributes are determined for each print mode available to the second printer. The appropriate degrees may be selected from each print apparatus based on the print mode selected for each print apparatus. In this manner, the plurality of print apparatus may be able to substantially match in non-color appearance for each print out among the plurality of devices so as to allow a source image to be printed by each of the devices and appear substantially the same.

Although the flow diagrams of FIGS. 8-15 illustrate specific orders of execution, the order of execution may differ from that which is illustrated. For example, the order of execution of the blocks may be scrambled relative to the order shown. Also, the blocks shown in succession may be executed concurrently or with partial concurrence. Further, blocks shown in a figure may be added to blocks of any number of figures to generate any combination of operations discussed herein, as appropriate. All such variations are within the scope of the present description.

All of the features disclosed in this specification (including any accompanying claims, abstract and drawings), and/or all of the elements of any method or process so disclosed, may be combined in any combination, except combinations where at least some of such features and/or elements are mutually exclusive.

The terms “include,” “have,” and variations thereof, as used herein, mean the same as the term “comprise” or appropriate variation thereof. Furthermore, the term “based on,” as used herein, means “based at least in part on.” Thus, a feature that is described as based on some stimulus may be based only on the stimulus or a combination of stimuli including the stimulus. “Substantial” and variations, as used herein, mean within a 10% threshold of a particularized amount. Furthermore, the use of the words “first,” “second,” or related terms in the claims are not used to limit the claim elements to an order or location, but are merely used to distinguish separate claim elements.

The present description has been shown and described with reference to the foregoing examples. It is understood, however, that other forms, details, and examples may be made without departing from the spirit and scope of the following claims.

What is claimed is:

1. An appearance calibration system comprising:
a profile engine to identify a printer setting corresponding to a non-color appearance attribute of an image source; and
a setting engine to set the printer setting according to the non-color appearance attribute of the image source.

2. The system of claim 1, wherein the profile engine is to:
identify a look-up table corresponding to the non-color appearance attribute of the image source; and
identify a setting level to apply to the printer setting via an entry in the look-up table corresponding to the degree of the non-color appearance attribute of the image source.

3. The system of claim 2, where the profile engine is to:
determine that the setting level corresponding to the degree of the non-color appearance attribute of the image source is beyond a configuration range of a first printer component corresponding to the non-color appearance attribute of the image source;
identify that the setting level corresponding to the degree of the non-color appearance attribute of the image source is within a tolerance threshold of a second printer component; and
select the second printer component and corresponding setting level as an alternative to the first printer component.

4. The system of claim 1, wherein the degree of the non-color appearance attribute of the image source is based on a target setting of a target printer component of a target print apparatus.

5. The system of claim 1, wherein:
the image source includes a plurality of layers corresponding to a plurality of appearance attributes and a first appearance attribute of the plurality of appearance attributes is the non-color appearance attribute; and
the profile engine is to determine a subset of the plurality of appearance attributes that are compatible with the print apparatus corresponding to the printer setting.

6. A non-transitory computer-readable storage medium comprising a set of instructions executable by a processor resource to:
identify a setting corresponding to a printer component that affects an appearance attribute;
identify a degree of the appearance attribute using a look-up table entry corresponding to the setting; and
provide a layer of appearance information representing the degree of the appearance attribute.

7. The medium of claim 6, wherein the set of instructions is executable by the processor resource to provide the layer of appearance information comprise instructions to:
add a plane of the appearance attribute to layers of color image data of an image source;
generate an electronic document with data representing the layer of appearance information in a format compatible with a target printer; or
causing presentation of configuration information on a display, the configuration information corresponding to adjustments to be made on the target printer to replicate the degree of the appearance attribute.

8. The medium of claim 6, wherein the set of instructions is executable by the processor resource to:
determine whether the appearance attribute is categorized; and
determine whether the appearance attribute is controllable.

9. The medium of claim 8, wherein the set of instructions is executable by the processor resource to:
provide a default value when the appearance attribute is determined to be categorized and uncontrollable; and
identify the degree of the appearance attribute in a look-up table using the setting of the printer component when the appearance attribute is determined to be categorized and controllable.

10. The medium of claim 6, wherein the set of instructions is executable by the processor resource to:
request a capability specification from a target printer including a range of the appearance attribute available on the target printer or measure the range of the appearance attribute available on the target printer using a calibration technique; and
determine the degree of the appearance attribute that is within the range of the appearance attribute available on the target printer using an appearance mapping technique.

11. A method of appearance matching among a plurality of printers comprising:
identifying a plurality of appearance attributes controllable between a first profile corresponding to a first printer of the plurality of printers and a second profile corresponding to a second printer of the plurality of printers, the plurality of appearance attributes including a non-color appearance attribute;
determining a degree of each attribute of the plurality of appearance attributes that is compatible with the first printer and the second printer based on the first profile and the second profile; and
preparing instructions for the first printer and the second printer to print a job using the degree of each attribute that is compatible with the first printer and the second printer.

12. The method of claim 11, comprising:
determining whether the non-color appearance attribute is categorized on the first printer and on the second printer;
determining whether the non-color appearance attribute is controllable on the first printer and the second printer;
adding a default value for each of the categorized appearance attributes of the first printer to the first profile; and
adding a range of values or a plurality of values for each of the controllable appearance attributes of the first printer to the first profile.

13. The method of claim 11, comprising:
looking up a first range for each attribute of the plurality of appearance attributes for the first printer;
looking up a second range for each attribute of the plurality of appearance attributes for the second printer; and
determining an intersection between the first range and the second range.

14. The method of claim 11, comprising:
determining a first printer component of the first printer corresponding to the non-color appearance attribute; and
determining a second printer component of the second printer corresponding to the non-color appearance attribute,
wherein a type of the first printer component is different from a type of the second printer component.

15. The method of claim 11, comprising:
selecting a group of look-up tables for each print mode available to the first printer and the second printer;
determining degrees for each appearance attribute of the plurality of appearance attributes for each print mode available to the first printer; and
determining degrees for each appearance attribute of the plurality of appearance attributes for each print mode available to the second printer.
